(19) United States
(12) Patent Application Publication
(10) Pub. No.: US 2005/0227890 A1
(43) Pub. Date: Oct. 13, 2005

(54) Detergent compositions with masked colored ingredients

(75) Inventors: Paul Irma Albertus Van Dijk, Putte (BE); Serge Omer Alfons Jean Thooft, Herzele (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/101,680

(22) Filed: Apr. 8, 2005

(30) Foreign Application Priority Data
Apr. 8, 2004 (EP) 04447091.2

(51) Int. Cl. C11D 17/00

(52) U.S. Cl. 510/276

(57) ABSTRACT

The present invention relates to a detergent composition comprising colored particles which are added at such a particle size, color and level that they are not noticeable to consumers. Such colored particle are added at less than 0.5% by weight of the total detergent composition and are characterized by Particle Size Distribution between 250 and 1250 μm, and by a Hunter color L value greater of from 40 to 100. The colored particle comprises a colored detergent ingredient which is a hueing agent.

### FIELD OF THE INVENTION

The present invention relates to detergent compositions comprising colored detergent ingredients which are added at such a particle size, color and level that they are not noticed by consumers.

### BACKGROUND OF THE INVENTION

The marketing of detergent products often involves the use of distinctive product aesthetics to help consumer differentiate one given product from another commercially available product of the same general type. Colored e.g. dyed or pigmented, speckles are sometimes used to create distinctiveness. It has been found that some consumers associate products having dyed particles with improved cleaning so that the consumer acceptance of products comprising colored particle can be higher than products not comprising such colored particles.

Detergents with colored speckles are indeed well known in the art such as: WO00/27980 discloses speckles particles having a specific sparkle index and transparency index which is colored by addition of a dye pigment and/or brightener. U.S. Pat. No. 6,541,437 discloses speckled detergent compositions comprising colored glassy phosphates. U.S. Pat. No. 4,097,418 relates to agglomerate colored speckles for use with white or lightly colored detergent granules to provide detergent composition having a distinctive and attractive appearance and which—because of the nature of the agglomerate colored speckles—are non staining to fabric in use. U.S. Pat. No. 4,671,886 discloses finely divided pigments which form large visible agglomerate admixed with a non-agglomerating granular diluent to break up the visible agglomerate of pigment in a premix, the premix being used to color granular products such as spray dried granules. U.S. Pat. No. 3,931,037 describes granular detergent product substantially uncolored in its dry state which contains coloring materials that are not subject to separation and segregation and are readily soluble or dispersible when the detergent is mixed with water to form a colored washing solution. However, the level of colored particles added to the detergent product in U.S. Pat. No. 3,931,037 is still rather high, at between 1% to 10% by weight of the composition, which enlarges the dosage of the detergent product and is wasteful for the environment. The present invention tackles this issue and enables the formulator to use much lower levels of colored particles in the final detergent product.

Furthermore and in order to meet the requirement of some users of detergents and/or to mask undesired color of detergent raw material, it can also be desirable to provide cleaning compositions that are substantially uncolored.

Therefore, the object of the present invention is to formulate colored detergent ingredients into detergent compositions at such a size, color and level, that those are not visible by consumers. The colored particles of the present invention can comprise a high level of colored ingredient and therefore can be formulated within the detergent composition at a low level. Such highly loaded colored particles at such low level are beneficial for the environment and furthermore provide room for other ingredients in the detergent formulation.

### SUMMARY OF THE INVENTION

The present invention relates to a detergent composition comprising less than 0.5% by weight of the total detergent composition, of a colored particle. Such colored particle comprises a colored detergent ingredient which is a hueing agent. The colored particle has a Particle Size Distribution between 250 μm and 1250 μm and a Hunter color L value of from 40 to 100.

### DETAILED DESCRIPTION OF THE INVENTION

The Colored Particle

The colored particle has a Hunter color L value of from 40 to 100, preferably of from 50 to 90, more preferably of from 60 to 75 and Particle Size Distribution (PSD) between 250 μm and 1250 μm, preferably 400 μm and 1000 μm, and more preferably between 600 μm and 800 μm. Preferably, the colored particle of the present invention has a Mean Particle Size (MPS) between 500 μm and 800 μm, and preferably between 600 μm and 700 μm.

The Hunter Color L Value

The Hunter colored L value of the colored particle of the present invention is measured as follows: A light source illuminates the surface of a sample and is reflected back to 3 filter-photocell detectors. The lightness and chromaticity or hue are measured and L, a, and b values assigned. The sample whose color is to be measured is placed in the sample container (70 mm diameter by 50 mm deep), and leveled at the top of this container before recording the Hunter color ‘L’ value using the Color Quest Meter (Color Quest-45/0, or equivalent).

The Particle Size Distribution (PSD) and Mean Particle Size (MPS)

The PSD and MPS of the colored particle of the present invention are measured as follows. The particle size distribution of granular detergent products, intermediates and raw materials are measured by sieving the granules/powders through a succession of sieves with gradually smaller dimensions. The weight of material retained on each sieve is then used to calculate a particle size distribution and median or mean particle size.

Equipment: RoTap Testing Sieve Shaker Model B (as supplied by: W.S. Tyler Company, Cleveland, Ohio), supplied with cast iron sieve stack lid with centrally mounted cork. The RoTap should be bolted directly to a flat solid inflexible base, preferably the floor. The tapping speed used should be 6 taps/minute with a 12 rpm elliptical motion. Samples used should weight 100 g, and total sieving time should be set at 5 mins.
Particle Size Distribution: The fraction on each sieve is calculated from the following equation:

$$Fraction on sieve ( \% ) = \frac{Mass on sieve ( g ) \times 100}{Original sample weight ( g )}$$

If this calculation is done for each sieve size used then a particle size distribution is obtained. However a cumulative particle size distribution is of more use. The cumulative distribution is calculated by adding the fractions on a particular sieve to the fractions on sieves above it (i.e. of higher mesh size).

Calculation of Mean particle size: Mean Particle Size is the geometric mean particle size on a mass basis calculated as the X intercept of the weighted regression line on the sigma versus log (size) plot.

The Colored Detergent Ingredient

The colored detergent ingredient of the present invention can be any detergent ingredient which has a substantially intense color as a raw material, such as enzymes, colored or dark clays. For the purpose of the present invention, the colored detergent ingredient is a hueing agent. The present invention enables the formulator to incorporate such hueing agents into detergent compositions in order to bring color to the fabric or wash solution.

A hueing agent is defined as a compound which upon washing provides white fabrics with a light off-white tint, modifying whiteness appearance and acceptance (e.g. bluish white, pinkish white). It can be colored material depositing on fabrics such as a pigment, a dye or a photo-bleach.

In a preferred embodiment of the present invention, the hueing agent is selected from dyes, pigments, photo-bleaches and mixtures thereof.

The colored detergent ingredient is comprised in the color particle at a level of from 20% to 60%, preferably from 30 to 50% by weight of the colored particle.

Dyes

Dyes are water soluble or water dispersible compounds that color the material onto which they have been anchored, by selectively absorbing certain wavelength of light. The principle feature of dyes is a conjugated system, allowing them to absorb energy in the visible part of the spectra. Most common conjugated systems are phtalocyanine, anthraquinone, azo, phenyl groups, referred to as chromophore. Dyes can be chosen from the following categories: reactive dyes, direct dyes, sulphur and azoic dyes, acid dyes and disperse dyes. Direct dyes are water soluble molecules. Examples of direct dyes are Direct orange 18, direct blue 86, direct yellow 50=lemon yellow, direct red 80=basic red. Reactive dyes are for example dichloro triazine, dichloro quinoxaline, chlorodifluoropyrimidine. Disperse dyes are for example disperse red 13, violet 33=fuchsia, Blue C-4RA=National blue.

Pigment

The colored detergent particle may also comprise as a colorant a pigment. Any pigment suitable for detergent compositions may be used herein. Pigments are insoluble colorants. Examples of pigments are Monastral Violet=Violet 19, Pigment Scarlet=Red 60, Blue cobaltous aluminate, and a preferred example is Ultra Marine Blue pigment.

Photo-Bleaches

Photo-bleaches are molecules, which absorb the energy from sunlight and transfer it by reacting with an other molecule (typically oxygen) to produce a bleaching specie (singlet oxygen). Photo-bleaches are extensively conjugated rings, and therefore usually present a strong visible color. Typical compounds are phthalocyanines, based on zinc, copper, or aluminum.

Other Ingredients

The colored particle may comprise other ingredients such as any material suitable for use in a detergent product, preferably a granular material. The material may be a complete detergent composition in itself, a usual ingredient in a detergent composition; and would include, but is not limited to surfactants, builders, bleaches or bleach precursors, zeolites, buffers, chelants, and mixtures thereof, or could include any material not incompatible with the other ingredients or the purpose of a detergent product. A particularly preferred granular material is a hydratable salt. Typically, the colored particle will comprise the colored detergent ingredient, a carrier and a binder. The colored particle can further comprise an opaque pigment and/or a coating.

Any binder material can be used herein. Preferred binders are selected from synthetic organic polymers such as polyethylene glycols, polyvinylpyrrolidones, polyacetates, water-soluble acrylate copolymers, and mixtures thereof. The handbook of Pharmaceutical Excipients; 2nd Edition has the following binder classification: Acacia, Alginic Acid, Carbomer, Carboxymethylcellulose sodium, Dextrin, Ethylcellulose, Gelatin, Guar Gum, Hydrogenated vegetable oil type 1, Hydroxyethyl cellulose, Hydroxypropyl methylcellulose, Liquid glucose, sugars and sugar alcohol such as sorbitol, manitol, Xylitol, Magnesium aluminum silicate, Maltodextrin, Methylcellulose, polymethacrylates, povidone, sodium alginate, starch and zein. Most preferred binder also have an active cleaning function in the wash such as cationic polymers. Examples include ethoxylated hexamethylene diamine quaternary compounds, bishexamethylene triamines or other such as pentaamines, ethoxylated polyethylene amines, maleic acrylic polymers.

Opaque Pigment

Opaque pigments do not transmit light. They can only reflect and eventually partly absorb incident light. Examples of opaque pigments are Titanium dioxide, Ultramarine blue, or Ultramarine violet.

Coating

A coating is a thin layer that is applied to an underlying material to form a protecting barrier between the two materials. This can either form a continuous or non-continuous layer around the material being coated. Good adhesion of the coating to the material being coated is important. A coating typically comprises a water soluble binder and an inorganic white or off-white pigment. Any binder material can be used herein. Preferred binders are described above. A non-limiting list of suitable pigments include titanium dioxide, zinc oxide, zinc sulfide, Lithopone, antimony trioxide, calcium carbonate, silicas, zeolites, Kaolin, Talc, and Barytes.

The colored particle may be colored by any method known in the art. Preferably the colorant is sprayed on or mixed with the crystalline material, preferably in the presence of a binder. Preferably, the colored particle herein may be colored with a colorant, preferably a dye a pigment and/or a brightener by spraying the colorant onto the crystalline material in a fluid bed dryer/coater or into a mixing-container or mix drum, containing the colored particles and optionally drying the colored speckle particles, preferably in a fluidized-bed.

The colored particles of this particle size may preferably be obtained by binding smaller particles with a binder, for example by agglomeration, as described herein. They may also be obtained from larger particle size material, for example by grinding this material. Also, the colored particle of this particle size may alternatively or additionally be obtained by sieving the particles and selecting the required particle size material. Other methods for controlling the particle size of such material are known to the skilled person and may also be used to obtain the particles of the required size.

Compositions

The colored particle is preferably present in detergent compositions, preferably granular detergent compositions, more preferably tablet detergent compositions at a level of from 0.01% to 0.5%, preferably from 0.05% to 0.3%, more preferably from 0.1% to 0.2% by weight of the (granular/tablet) detergent composition.

The detergent tablet of the present invention can be formulated for use in any cleaning process such as dishwashing, hard surface cleaning and laundry, preferably for use in a fabric washing process. They are preferably in the form of granules, extrudates, flakes or tablets. They may additional comprise any conventional ingredient commonly employed in detergent compositions.

The detergent compositions can comprise a wide variety of different ingredients, such as building agents, effervescent system, enzymes, dissolution aids, disintegrants, bleaching agents, suds supressors, surfactants (nonionic, anionic, cationic, amphoteric, and/or zwitterionic), fabric softening agents, alkalinity sources, colorants, perfumes, lime soap dispersants, organic polymeric compounds including polymeric dye transfer inhibiting agents, crystal growth inhibitors, anti-redeposition agents, soil release polymers, hydrotropes, fluorescents, heavy metal ion sequestrants, metal ion salts, enzyme stabilisers, corrosion inhibitors, optical brighteners, and combinations thereof. The compositions herein can also be used as detergent additive products. Such additive products are intended to supplement or boost the performance of conventional detergent compositions and can be added at any stage of the cleaning process.

Granular Composition

The colored particle of the present invention can be encompassed in any detergent granular composition.

Making of the Colored Particle

The colored particle of the present invention can be produced by any process wherein the colored ingredients, and optionally further ingredients, are combined to form a mixture. The mixture may be in any form, such as a liquid, slurry, or a solid material, such as a granule, or a particulate. The mixture may be formed into particulate materials, such as granules by for example an extrusion process, a fluid bed process, rotary atomization, agglomeration or a moulding process. Preferably, the granules are formed by an agglomeration and/or a Fluid bed process. The agglomeration and also the Fluid bed process, provide a simple, fast, efficient, cost-effective means of preparing a granule.

For the preparation of the mixture, any type of mixer may be used, especially a dynamic mixer. The mixing equipment will need to be selected to handle the relatively high viscosities that the mixture will reach. The exact viscosity will depend on the composition of the mixture and on the processing temperature. Preferably the processing temperature is below 120° C., preferably below 100° C., more preferably below 80° C., and most preferably between 40° C. and 75° C.

The mixture may be subsequently granulated by various process means. Preferred means are described in more detail below:

Fine Mixing and Granulation

Suitable pieces of equipment in which to carry out the fine mixing or granulation of the present invention are mixers of the Fukae® FS-G Series manufactured by Fukae Powtech Kogyo Co. Japan. This apparatus is essentially in the form of a bowl-shaped vessel accessible via a top port, provided near its base with a stirrer having substantially vertical axis, and a cutter positioned on a side wall. The stirrer and cutter may be operated independently of one another and at separately variable speeds. The vessel can be fitted with a heating or cooling jacket. Other similar mixers found to be suitable for use in the process of the invention include Diosna® V series ex Dierks & Söhne, Germany; and the Pharma Matrix® ex T K Fielder Ltd., England. Other mixers believed to be suitable for use in the process of the invention are the Fuji® VG-C series ex Fuji Sangyo Co., Japan; and the Roto® ex Zanchetta & Co srl, Italy.

Other preferred suitable equipment can include Eirich® Series R and RV, manufactured by Gustau Eirich Hardheim, Germany; Lödige, Series FM for batch mixing or series CB and KM, either separately or in series for continues mixing/agglomeration, manufactured by Lödige Maschinenbau GmbH, Paderborn Germany; Drais® T 160 Series, manufactured by Drais Werke GmbH, Mannheim, Germany; and Winkworth® RT 25 series, manufactured by Winkworth Manchinery Ltd., Berkshire, England. The Littleford Mixer, Model #FM-130-D-12, with internal chopping blades and the Cuisinart Food Processor, Model #DCX-Plus, with 7.75 inch (19.7 cm) blades are two more examples of suitable mixers. Any other mixer with fine mixing and granulation capability and having a residence time in the order of 0.1 to 10 minutes can be used. The “turbine-type” impeller mixer, having several blades on an axis of rotation, is preferred. The invention can be practiced as a batch or a continuous process. Other suitable equipments are a fluid bed coater or Wurster coater manufactured by Glatt GMBH in Germany.

Further Processing Steps

The colored particles obtained by the processes above are suitable for direct use, or may be treated by additional process steps such as the commonly used steps drying and or cooling, and/or dusting. The colored particles of the present invention are typically blended with other detergent component to form a fully formulated detergent composition.

The detergent components can be screened through different sieves. The weight mean particle size of the detergent components will generally be from 200 μm to 2000 μm, preferably being at least 300 μm and not above 1700 μm, preferably below 1600 μm. This weight mean particle size can for example be determined by sieve analysis, for example by sieving a sample of the particulate relevant material herein through a series of sieves, typically 5, with meshes of various diameter or aperture size, obtaining a number of fraction (thus having a particle size of above, below or between the mesh size of the used sieve size). Preferably at least 70% or even at least 80% by weight of said granule has a particle size from 200 μm to 2000 μm, more preferably from 300 μm to 1700 μm, and most preferably from 380 μm to a 1550 μm.

The density of the detergent component of the present invention will generally be above 300 kg/m³, preferably greater than 400 kg/m³ or even greater than 500 kg/m³. The density of the detergent granule according to the invention will generally be below 1500 kg/m³, preferably below 1200 kg/m³.

Tablet Composition

In a preferred embodiment, the detergent composition of the present invention is a detergent tablet. These can be made by tabletting a detergent base powder. The base powder is typically a pre-formed detergent granule, typically made either by a spray-drying or agglomeration, or other process.

It is preferred that the detergent tablets herein comprise a disintegration aid, such as:

1. The compositions herein can comprise a disintegrant that will swell on contact with water. Possible disintegrants for use herein include those described in the Handbook of Pharmaceutical Excipients (1986). Examples of suitable disintegrants include clays such as bentonite clay; starch: natural, modified or pregelatinised starch, sodium starch gluconate; gum: agar gum, guar gum, locust bean gum, karaya gum, pectin gum, tragacanth gum; croscarmylose sodium, crospovidone, cellulose, carboxymethyl cellulose, algenic acid and its salts including sodium alginate, silicone dioxide, polyvinylpyrrolidone, soy polysaccharides, ion exchange resins, and mixtures thereof.

2. Preferably the tablets will be coated so that the tablet does not absorb moisture, or absorbs moisture at only a very slow rate. The coating can improve the mechanical characteristics of a shaped composition while maintaining or improving dissolution. This very advantageously applies to single and multi-layer tablets, whereby the mechanical constraints of processing can be mitigated through the use of the coating, thus improving mechanical integrity of the tablet. The preferred coatings and methods for use herein are described on page 3, line 28 to page 4, line 12 of EP-A-846,754 (published by the Procter & Gamble Company on Jun. 10, 1998). As specified therein, preferred coating ingredients are for example dicarboxylic acids. Particularly suitable dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid. Preferably the coating comprises a disintegrant, as described hereinabove, that will swell on contact with water and break the coating into small pieces. Preferably the coating comprises a cation exchange resins, such as those sold by Purolite under the names Purolite® C100NaMR, a sodium salt sulfonated poly(styenedivinylbenzene) co-polymer and Purolite® C100CaMR, a calcium salt sulfonated poly(styene-divinylbenzene) co-polymer.

3. The compositions herein can comprise an effervescent. As used herein, effervescency means the evolution of bubbles of gas from a liquid, as the result of a chemical reaction between a soluble acid source and an alkali metal carbonate, to produce carbon dioxide gas. The addition of this effervescent to the detergent improves the disintegration time of the compositions. The amount will preferably be from 0.1% to 20%, more preferably from 5% to 20% by weight of composition. Preferably the effervescent should be added as an agglomerate of the different particles or as a compact, and not as separate particles.

4. Further dispersion aid could be provided by using compounds such as sodium acetate, nitrilotriacetic acid and salts thereof or urea. A list of suitable dispersion aid may also be found in Pharmaceutical Dosage Forms: Tablets, Vol. 1, 2nd Edition, Edited by H. A. Lieberman et al, ISBN 0 8044 5. Non-gelling binding can be integrated to the particles forming the tablet in order to facilitate dispersion. Preferred binder have been described herein above.

5. The compositions herein may also comprise expandable clays. As used herein the term “expandable” means clays with the ability to swell (or expand) on contact with water. These are generally three-layer clays such as aluminosilicates and magnesium silicates having an ion exchange capacity of at least 50 meq/100 g of clay. The three-layer expandable clays used herein are classified geologically as smectites. Example clays useful herein include montmorillonite, volchonskoite, nontronite, hectorite, saponite, sauconitem, vermiculite and mixtures thereof. The clays herein are available under various 5 tradenames, for example, Thixogel #1 and Gelwhite GP from Georgia Kaolin Co., Elizabeth, N.J., USA; Volclay BC and Volclay #325 from American Colloid Co., Skokie, Ill., USA; Black Hills Bentonite BH450 from International Minerals and Chemicals; and Veegum Pro and Veegurn F, from R.T. Vanderbilt. It is to be recognised that such smectite-type minerals obtained under the foregoing tradenames can comprise mixtures of the various discrete mineral entities. Such mixtures of the smectite minerals are suitable for use herein.

6. The compositions of the present invention may comprise a highly soluble compound. Such a compound could be formed from a mixture or from a single compound. Examples include salts of acetate, urea, citrate, phosphate, sodium diisobutylbenzene sulphonate (DIBS), sodium toluene sulphonate, and mixtures thereof.

7. The compositions herein may comprise a compound having a Cohesive Effect on the detergent matrix forming the composition. The Cohesive Effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength (also refer to diametrical fracture stress) are given in Pharmaceutical dosage forms: tablets volume 1 Ed. H. A. Lieberman et al, published in 1989. The cohesive effect is measured by comparing the tablet or layer strength of the original base powder without compound having a cohesive effect with the tablet or layer strength of a powder mix which comprises 97 parts of the original base powder and 3 parts of the compound having a cohesive effect. The compound having a cohesive effect is preferably added to the matrix in a form in which it is substantially free of water (water content below 10% (pref. below 5%)). The temperature of the addition is between 10 and 800° C., more pref. between 10 and 400° C. A compound is defined as having a cohesive effect on the particulate material according to the invention when at a given compacting force of 3000N, tablets with a weight of 50 g of detergent particulate material and a diameter of 55 mm have their tablet tensile strength increased by over 30% (preferably 60 and more preferably 100%) by means of the presence of 3% of the compound having a cohesive effect in the base particulate material. An example of a compound having a cohesive effect, is sodium diisoalkylbenzene sulphonate.

Tablet Making

Tablets can be prepared simply by mixing the solid ingredients together and compressing the mixture in a conventional tablet press as used, for example, in the pharmaceutical industry, in the food industry, or in the detergent industry. The detergent tablets can be made in any size or shape and can, if desired, be coated. They can be made by tabletting a detergent base powder. The base powder is typically a pre-formed detergent granule The pre-formed detergent granules may be spray-dried, agglomerated particles or in any other form. The average particle size of the base powder is typically from 100 μm to 2,000 μm, preferably from 200 μm, or from 300 μm, or from 400 μm, or from 500 μm and preferably to 1,800 μm, or to 1,500 μm, or to 1,200 μm, or to 1,000 μm, or to 800 μm, or to 700 μm. Most preferably, the average particle size of the base powder is from 400 μm to 700 μm. The bulk density of the base powder is typically from 400 g/l to 1,200 g/l, preferably from 500 g/l to 950 g/l, more preferably from 600 g/l to 900 g/l, and most preferably from 650 g/l to 850 g/l.

An example of such a process is spray drying (in a co-current or counter current spray drying tower) which typically gives low bulk densities 600 kg/m³ or lower. Particulate materials of higher density can be prepared by granulation and densification in a high shear batch mixer/granulator or by a continuous granulation and densification process (e.g. using Lödige TM CB and/or Lödige TM KM mixers). Other suitable processes include fluid bed processes, compaction processes (e.g. roll compaction), extrusion, as well as any particulate material made by any chemical process like flocculation, crystallisation sentering, etc Individual particles can also be any other particle, granule, sphere or grain.

In a preferred embodiment, an automated Steam injection system is installed into the air inlet of the Fluid Bed Dryer or Fluid Bed Cooler of a detergent base particle or other particle making process, so the Relative Humidity from the air used to dry or cool down particles can be controlled and/or increased, resulting in controlling the physical properties of the particles, independent from outside weather conditions. This device enables a constant humidity (vapor density) of the air feed to the fluid bed. The system to inject steam in the Fluid Bed Dryer or Fluid Bed Cooler inlet can be used for any application were product needs to be dried and or cooled and Relative Humidity of the incoming air is influencing the properties of the product.

The particulate materials may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). A binder, preferably a non-gelling binder; can be sprayed on to the mix of some, or, on the mix of all of the particulate materials, either separately or premixed. For example perfume and slurries of optical brighteners may be sprayed. A finely divided flow aid (dusting agent such as zeolites, carbonates, silicas) can be added to the particulate materials after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy TM, Korch TM, Manesty TM, or Bonals TM). Tablets prepared should preferably have a diameter of between 40 mm and 60 mm, and a weight between 25 g and 100 g. The ratio of height to diameter (or width) of the tablets is preferably greater than 1:3, more preferably greater than 1:2. The compaction pressure used for preparing these tablets need not exceed 5000 kN/m², preferably not exceed 3000 kN/m², and more preferably not exceed 2000 kN/m². The detergent tablet typically has a diameter of between 20 mm and 60 mm, and typically having a weight of from 10 g to 100 g. The ratio of tablet height to tablet width is typically greater than 1:3. The tablet typically has a density of at least 900 g/l, preferably at least 950 g/l, and preferably less than 2,000 g/l, more preferably less than 1,500 g/l, most preferably less than 1,200 g/l. The detergent tablets of the present invention can be dosed to the laundry machine via the drawer or directly into the drum, potentially via a dispending device, such as a net.

### EXAMPLES

All percentages, parts and ratios are by weight unless otherwise indicated.

### Example 1

4.1 kg of Ultra Marine Blue and 3.9 kg of TiO₂ were fed to a VG 25 granulator. The mixer was switched-on at 400 rpm to mix the 2 ingredients. 2.3 kg of an aqueous solution containing 70% by weight of sorbitol was sprayed (2 bar pressure at rate of 180 g/min) onto the powder-mix producing agglomerates after ±13 min of mixing. After the agglomerates were made 500 g of zeolite was added for dusting. This final agglomerate was added to a fluid bed dryer and dryed for 5 min with an air inlet temperature of 100° C.

The colored particle thus obtained has a HUNTER VALUE L of 55.81 a PSD between 200 μm and 1180 μm and a MPS of 537 μm. When mixed in a detergent matrix at a level of 0.5% the particles are invisible.

### Example 2

4.1 kg of Ultra Marine Blue and 3.9 kg of TiO₂ were fed to a VG 25 granulator. The mixer was switched-on at 400 rpm to mix the 2 ingredients. 2.3 kg of an aqueous solution containing 70% by weight of sorbitol was sprayed (2 bar pressure at rate of 180 g/min) onto the powder-mix producing agglomerates after +13 min of mixing. After the agglomerates were made 1000 g of TiO₂ was added for dusting. This final agglomerate was added to a fluid bed dryer and dried for 5 min with an air inlet temperature of 100° C. The colored particle thus obtained has a HUNTER VALUE L of 63.66 a PSD between 200 μm and 1180 μm and a MPS of 594 μm. When mixed in a detergent matrix at a level of 0.5% the particles are invisible.

### Example 3

The fluid bed is filled with 6 kg Sodium Sulfate. A 50% watery solution containing 8 kg Pigmasol Green, and 2.2 kg Sorbitol binder is sprayed and simultaneously dried by the hot fluidizing air. The process continuous until all the solution is sprayed on Sodium Sulfate. A dark Green particle is produced. After this first particle making, a second layer (40% watery solution containing 3 kg TiO₂ and 1 kg Sorbitol as binder), is sprayed (and simultaneously dried by the hot fluidizing air) on the first particles. The colored particle thus obtained has a HUNTER VALUE L of 66.19, a PSD between 200 μm and 1180 μm and a MPS of 702 μm. When mixed in a detergent matrix at a level of 0.5% the particles are invisible.

### Example 4

The fluid bed is filled with 6 kg Sodium Sulfate. A 50% watery solution containing 8 kg Ultra Marine Blue, and 2.2 kg acrylic-maleic-copolymer (CP-5) binder is sprayed and simultaneously dried by the hot fluidizing air. The process continuous until all the solution is sprayed on Sodium Sulfate. A dark blue particle is produced. After this first particle making a second layer (40% watery solution containing 3 kg TiO₂ and 1 kg acrylic-maleic-copolymer (CP-5) as binder), is sprayed (and simultaneously dried by the hot fluidizing air) on the first particles. The colored particle thus obtained has a HUNTER VALUE L of 62.75, a PSD between 200 μm and 1180 μm and a MPS of 586 μm. When mixed in a detergent matrix at a level of 0.5% the particles are invisible

### Example 5

### Laundry Detergent Tablet Composition

The detergent composition was prepared by admixing the granular components in a mixing drum for 5 minutes to create a homogenous particle mixture. During this mixing, the spray-on's were carried out with a nozzle and hot air using a binder. The tablet composition was prepared using an Instron 4400 testing machine and a standard die for manual tablet manufacturing. 35 g of the detergent core was fed into the dye of 41×41 mm with rounded edges that has a ratio of 2.5 mm. The mix was compressed with a force of 2000 N with a punch that has a suitable shape to form a concave mold of 25 mm diameter and 10 mm depth in the tablet. The tablet is then manually ejected from the dye.

TABLE 1

| Base powder ingredients² | A | B |
|---|---|---|
| Anionic / Cationic agglomerates³ | 36 | 33.5 |
| Anionic Agglomerates⁴ | — | 1.5 |
| Nonionic agglomerates⁵ | 12 | 4.5 |
| Clay extrudate⁶ | — | 8 |
| Layered Silicate⁷ | 1 | 2 |
| Sodium Percarbonate | 10 | 15 |
| Bleach activator agglomerates 1⁸ | 4 | 3 |
| Sodium Carbonate | 12 | 12 |
| EDDS/Sulphate particle⁹ | 0.6 | 0.2 |
| Tetrasodium salt of Hydroxyethane | | |
| Diphosphonic acid | 0.5 | 0.3 |
| Soil Release Polymer | 6 | 2.5 |
| Fluorescer | 0.1 | 0.1 |
| Zinc Phthalocyanide sulphonate | | |
| encapsulate¹⁰ | 0.05 | 0.01 |
| Suds supressor¹¹ | 2 | 1.5 |
| Soap | — | 0.8 |
| Citric acid | 3 | 4 |
| Sodium Citrate | 3 | 2 |
| Sodium Acetate | 4 | 3 |
| Protease | 0.5 | 0.3 |
| Amylase | 0.2 | 0.05 |
| Cellulase | — | 0.1 |
| Perfume | 0.6 | 1 |
| Colored particle from examples 1 to 4 | 0.05 | 0.4 |
| Binder system¹² | 1.7 | 3.5 |
| Miscellaneous | to 100% | to 100% |

²Values given in Table 1 are percentages by weight of the total detergent tablet.
³Anionic / Cationic agglomerates comprise from 20% to 45% anionic surfactant, from 0.5% to 5% cationic surfactant, from 0% to 5% TAE80, from 15% to 30% SKS6, from 10% to 25% zeolite, from 5% to 15% acetate, from 0% to 5% carbonate, from 0% to 5% sulphate, from 0% to 5% silicate and from 0% to 5% water.
⁴Anionic agglomerates comprise from 40% to 80% anionic surfactant and from 20% to 60% DIBS.
⁵Nonionic agglomerates comprise from 20% to 40% nonionic surfactant, from 0% to 10% polymer, from 30% to 50% sodium acetate anhydrous, from 15% to 25% carbonate and from 5% to 10% zeolite.
⁶Clay agglomerates comprise from 90% to 100% of CSM Quest 5A clay, from 0% to 5% alcohol or diol, and from 0% to 5% water.
⁷Layered silicate comprises from 90% to 100% SKS6 and from 0% to 10% silicate.
⁸Bleach activator agglomerates 1 comprise from 65% to 75% bleach activator, from 10% to 15% anionic surfactant and from 5% to 15% sodium citrate.
⁹Ethylene diamine N,N-disuccinic acid sodium salt/Sulphate particle comprises from 50% to 60% ethylene diamine N,N-disuccinic acid sodium salt, from 20% to 25% sulphate and from 15% to 25% water.
¹⁰Zinc phthalocyanine sulphonate encapsulates are from 5% to 15% active.
¹¹Suds suppressor comprises from 10% to 15% silicone oil (ex Dow Corning), from 50% to 70% zeolite and from 20% to 35% water.
¹²The binder systems used in compositions A and B are respectively 90% sorbitol and 10% water, or 85% PEG 4000 and 15% cyclohexyldimethanol.
The detergent tablets of example 5 above (40 g each), can be coated by dipping the tablet into a mixture of 95 g adipic acid with 5 g calcium polystyrene sulphonate resin (ex. Purolite), at a temperature of 160° C.

### Example 6

### Powder Detergent Composition

TABLE 2

| Base powder ingredients² | A | B |
|---|---|---|
| Anionic surfactant | 8 | 10 |
| Cationic surfactant | 1.0 | 1 |
| Nonionic surfactant | 3.0 | 0 |
| Clay extrudate⁶ | 0 | 12 |
| Alumino-silicate | 15 | 10 |
| Layered Silicate⁷ | 4 | 4 |
| Sodium Percarbonate | 12 | 12 |
| Bleach activator agglomerates 1⁸ | 4 | 3 |
| Sodium Carbonate | 14 | 14 |
| Sodium sulphate | 23 | 20 |
| EDDS/Sulphate particle⁹ | 0.5 | 0.5 |
| Tetrasodium salt of Hydroxyethane | 0.2 | 0.1 |
| Diphosphonic acid | | |
| Soil antiredeposition polymer | 1.7 | 1 |
| Soil Release Polymer | 0 | 1 |
| Dye transfer inhibitor | 0.1 | 0.5 |
| Fluorescer | 0.1 | 0.1 |
| Zinc Phthalocyanide sulphonate | 0.03 | 0.02 |
| encapsulate¹⁰ | | |
| Suds supressor¹¹ | 1.0 | 1.0 |
| Citric acid | 3 | 1 |
| Protease | 0.1 | 0.2 |
| Amylase | 0.2 | 0.2 |
| Cellulase | 0 | 0.2 |
| Perfume | 0.5 | 0.4 |
| Colored particle from examples 1 to 4 | 0.1 | 0.2 |
| Miscellaneous | to 100% | to 100% |

2. Values given in Table 2 are percentages by weight of the total detergent tablet. 6, 7, 8, 9, 10, 11 are defined as above.

### Example 7

### Automatic Dishwashing Tablet Composition

TABLE 3

| | % by weight |
|---|---|
| Detergent actives | in finished product |
| Nonionic surfactant | 2.7 |
| Paraffin | 0.5 |
| Sodium Perborate | 7.0 |
| Penta amino aceto nitrate cobalt III | 0.01 |
| Sodium Carbonate | 15 |
| Sodium Sulphate | 8 |
| Benzotriazole | 0.3 |
| Amylase | 1.0 |
| Protease | 0.8 |
| sodium silicate | 2.0 |
| Layered silicate | 6.0 |
| Sodium tripolyphosphate | 44 |
| Dye | 0.005 |
| Perfume | 0.10 |
| Hydroxyethylene diphosphonic acid (sodium | 0.2 |
| salt) | |
| PEG 8000 | 0.3 |
| PEG 4000 | 1.6 |
| PEG 400 | 0.1 |
| Colored particle from examples 1-4 | 0.3 |
| Water | 6.5 |
| Miscellaneous | To 100% |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent composition comprising from about 0.01% to about 0.5% by weight of the detergent composition, of a colored particle comprising a colored ingredient which is a hueing agent, the colored particle having a Particle Size Distribution between about 250 μm and about 1250 μm and a Hunter color L value of from about 40 to about 100.

2. A detergent composition according to claim 1 wherein the colored particle is comprised at a level of about 0.05% to about 0.3% by weight of the detergent composition.

3. A detergent composition according to claim 2 wherein the colored particle is comprised at a level of about 0.1% to 0.2% by weight of the detergent composition.

4. A detergent composition according to claim 1 wherein the colored particle has a Particle Size Distribution between about 400 μm and about 1000 μm.

5. A detergent composition according to claim 4 wherein the colored particle has a Particle Size Distribution between about 600 μm and about 800 μm.

6. A detergent composition according to claim 1 wherein the colored particle has a Hunter color L value of from about 50 to about 90.

7. A detergent composition according to claim 6 wherein the colored particle has a Hunter color L value of from about 60 to about 75.

8. A detergent composition according to claim 1 wherein the hueing agent is selected from the group consisting of dyes, pigments, photo-bleaches and mixtures thereof.

9. A detergent composition according to claim 8 wherein the hueing agent is Ultra Marine Blue.

10. A detergent composition according to claim 1 wherein the colored particle has a Mean Particle Size between about 500 μm and about 800 μm.

11. A detergent composition according to claim 10 wherein the colored particle has a Mean Particle Size between about 600 μm and about 700 μm.

12. A detergent composition according to claim 1 wherein the colored particle further comprise an opaque pigment.

13. A detergent composition according to claim 1 wherein the colored particle is coated.

14. A detergent composition according to claim 12 wherein the colored particle comprises titanium dioxide as an opaque pigment.

15. A detergent composition according to claim 13 wherein the colored particle comprises titanium dioxide as coating.

16. A detergent composition according to claim 1 which is the form of a tablet.

17. A detergent composition in form of a tablet comprising from about 0.05% to 0.3% by weight of the detergent composition, of a colored particle comprising a colored ingredient which is dye, the colored particle having a Particle Size Distribution between about 400 μm and about 1000 μm, a Mean Particle Size between about 500 μm and about 800 μm and a Hunter L value of from about 50 to about 90 wherein the colored particle comprises titanium dioxide as coating.

18. A detergent composition in form of a tablet comprising from about 0.05% to 0.3% by weight of the detergent composition, of a colored particle comprising a colored ingredient which is dye, the colored particle having a Particle Size Distribution between about 400 μm and about 1000 μm, a Mean Particle Size between about 500 μm and about 800 μm and a Hunter L value of from about 50 to about 90 wherein the colored particle comprises titanium dioxide as an opaque pigment.

19. A detergent composition in form of a tablet comprising from about 0.05% to 0.3% by weight of the detergent composition, of a colored particle comprising a colored ingredient which is dye, the colored particle having a Particle Size Distribution between about 400 μm and about 1000 μm, a Mean Particle Size between about 500 μm and about 800 μm and a Hunter L value of from about 50 to about 90 wherein the colored particle comprises titanium dioxide as an opaque pigment and as coating.
